(19) United States
(12) Patent Application Publication
(10) Pub. No.: US 2025/0323517 A1
(43) Pub. Date: Oct. 16, 2025

(54) CHARGING DOCK FOR VR DEVICE

(71) Applicant: PRISMXR PTE LTD, Singapore (SG)

(72) Inventor: Qiang WENG, Singapore (SG)

(73) Assignee: PRISMXR PTE LTD, Singapore (SG)

(21) Appl. No.: 18/786,264

(22) Filed: Jul. 26, 2024

(30) Foreign Application Priority Data
Apr. 16, 2024 (CN) 202420790624.7

(51) Int. Cl. H02J 7/00; G06F 1/16

(52) U.S. Cl. CPC H02J 7/0044; G06F 1/163; G06F 1/1632

(57) ABSTRACT

The present disclosure provides embodiments of a charging dock for a VR device, including: a base, a charging bin, disposed obliquely to the base, where the charging bin is provided with a VR device containing cavity and a control device containing cavity, a first charging apparatus is provided in the VR device containing cavity, and a second charging apparatus is provided in the control device containing cavity; where the first charging apparatus is disposed in parallel with a charging interface on the VR device, and when the VR device is placed in the VR device containing cavity, the first charging apparatus is docked in parallel with the charging interface.

### FIELD

The present disclosure relates to the technical field of VR device, in particular to a charging dock for a VR device.

### BACKGROUND

A VR device, in other words, a VR headset, is a virtual reality headset display device, which is a product combining various technologies, including simulation technology, computer graphics, human-computer interface technology, multimedia technology, sensor technology, and network technology, etc., which is also a brand-new human-computer interaction means created by computer and sensor technology. The VR headset is mainly used for video or games, which can effectively improve the experience of video and games. In order to make the use experience of the VR headset better, the VR headset is usually equipped with a power supply, and the VR headset can be placed on the charging dock to charge after use.

However, due to the uneven weight distribution of the VR headset, the VR headset placed on the charging dock is easy to shift due to the instability of the center of gravity, resulting in poor contact of the charging connector. In addition, because the VR headset device needs to be worn on the head, a strap is usually required to be installed on the VR headset device. Due to the influence of the strap, the instability of the center of gravity of the VR headset device may further aggravate, and it is more difficult to carry out stable and reliable charging.

### SUMMARY

In view of the above problems, embodiments of the present disclosure are proposed, the purpose of which is to provide a charging dock for a VR device.

In one embodiment of the present disclosure, a charging dock for a VR device is provided, which includes:
a base,
a charging bin, disposed obliquely to the base, wherein the charging bin is provided with a VR device containing cavity and a control device containing cavity, a first charging apparatus is provided in the VR device containing cavity, and a second charging apparatus is provided in the control device containing cavity;
wherein, the first charging apparatus is disposed in parallel with a charging interface on the VR device, and when the VR device is placed in the VR device containing cavity, the first charging apparatus is docked in parallel with the charging interface.

Optionally, the VR device containing cavity is located at a front side of the control device containing cavity, along a tilting direction of the charging chamber;
the first charging apparatus is disposed on a side wall of an edge of the VR device containing cavity; and
the second charging apparatus is disposed on a side wall of the control device containing cavity.

Optionally, a containing slot is provided in the VR device containing cavity, the first charging apparatus is provided in the containing slot, and the first charging apparatus is able to extend from the containing slot to dock with the charging interface.

Optionally, the first charging apparatus is provided with a first magnetic piece, and when the first charging apparatus is docked with the charging interface, the first charging apparatus is able to extend from the containing slot and attract and attach the charging interface.

Optionally, the first charging apparatus comprises: a top cover, a bottom cover, a charging pogo pin and a reset piece;
the charging pogo pin is disposed on the top cover, the first magnetic piece is bonded to a top surface of the bottom cover, and the top cover covers and buckles on the top surface of the bottom cover; and
the reset piece is disposed on a bottom surface of the bottom cover, one end of the reset piece is connected against the bottom cover, and the other end of the reset piece is connected against a housing of the charging bin, for driving the bottom cover to retract.

Optionally, a second magnetic piece is provided in the charging interface, when the VR device is placed in the VR device containing cavity, the second magnetic piece attracts the first magnetic member, to drive a compress of the reset piece, the first charging apparatus extends, and attracts and attaches the charging interface.

Optionally, wherein an end of the containing slot facing outside is in a flaring shape, the first charging apparatus is able to extend or retreat along a depth direction of the containing slot, and is also able to tilt out or retreat along a width and/or a length direction of the containing slot.

Optionally, a maximum angle of the first charging apparatus being able to tilt forward and a maximum angle of the first charging apparatus being able to tilt backward are different along the length direction of the containing slot; and
an angle range of the first charging apparatus being able to tilt forward is [0 degrees to 20 degrees], and an angle range of the first charging apparatus being able to tilt backward is [0 degrees to 15 degrees].

Optionally, the charging dock for the VR device further includes a positioning bracket and a magnetic attracting piece;
wherein the positioning bracket comprises a positioning structure and a mounting hole, and the positioning structure is matched with a part of a shell of the VR device, when the positioning structure is installed in place, the mounting hole is matched and aligned with the charging interface, and the magnetic attracting piece is able to be installed on an outside of the charging interface via the mounting hole.

Optionally, the magnetic attracting piece comprises a magnetic attracting cover, a third magnetic piece and a connecting piece;
the magnetic attracting cover is provided with an opening hole, the third magnetic piece is disposed at an edge of the opening hole, and the connecting piece is used to connect the magnetic attracting cover to the shell of the VR device; and
the charging interface is located at a position corresponding to the opening hole, when the VR device is placed in the VR device containing cavity, the third magnetic piece attracts the first charging apparatus, the first charging apparatus is connected with the charging interface via the opening hole.

Optionally, the second charging apparatus comprises a fourth magnetic piece and a charging column arranged at an interval; and
the fourth magnetic member is disposed at a position corresponding to the control device containing cavity, and the charging column protrudes from the side wall of the control device containing cavity.

Optionally, the control device containing cavity comprises at least one control device containing position, when the control device containing cavity has multiple control device containing positions, each control device containing position is correspondingly provided with one second charging apparatus.

Optionally, the charging dock for the VR device further includes a support frame, the support frame comprises a connecting component and a support component;
the support component is disposed at an end of the connecting component, and the other end of the connecting component is used to connect with the base or the charging bin;
along the tilting direction of the charging chamber, the support component is located at a rear side of the charging bin, and a support surface of the support component is higher than a top of the charging bin.

In the technical solution provided by the present disclosure, by disposing the charging bin obliquely, the VR device can be placed in the charging bin obliquely correspondingly, thus effectively avoiding the problem of unstable center of gravity of the VR device. In addition, by disposing the first charging apparatus in parallel with a charging interface on the VR device, the first charging apparatus is able to be stably connected with the charging interface, ensuring the stable and reliable charging.

### BRIEF DESCRIPTION OF THE DRAWINGS

In order to describe the technical solutions in the embodiments of the present disclosure or the prior art more clearly, the drawings required to be used for descriptions about the embodiments or the prior art will be simply introduced below. It is apparent that the drawings described below are some embodiments of the present disclosure. Those of ordinary skill in the art may further obtain other drawings according to these drawings without creative work.

FIG. 1 a structure diagram of a VR device and a charging dock thereof provided by embodiments of the present disclosure;

FIG. 2 is a structural diagram of a charging dock for a VR device provided by embodiments of the present disclosure;

FIG. 3 is an exploded diagram of a charging dock for a VR device provided by embodiments of the present disclosure;

FIG. 4 is an installation diagram of a positioning bracket provided by embodiments of the present disclosure;

FIG. 5 is a structural diagram of a control device provided by embodiments of the present disclosure;

FIG. 6 an exploded diagram of a control device provided by embodiments of the present disclosure;

FIG. 7 is a structural diagram of another VR device and a charging dock thereof provided by embodiments of the present disclosure;

FIG. 8 a partial exploded diagram of a charging dock for a VR device provided by embodiments of the present disclosure;

FIG. 9 is a section view of a charging dock for a VR device provided by embodiments of the present disclosure; and

FIG. 10 is a partial view of area A in FIG. 9.

### DETAILED DESCRIPTION OF EXAMPLE EMBODIMENTS

The present disclosure is further explained in detail in combination with the attached drawings and embodiments below. It is understood that the specific embodiments described herein are intended only to explain the present disclosure and not to define the present disclosure. It should also be noted that, in order to facilitate description, only the parts related to the present disclosure are shown in the attached drawings, not the whole structure.

In the description of the present disclosure, unless otherwise expressly specified and limited, the terms “connected”, “connection”, “fixed”, etc., shall be understood broadly, for example, can be a fixed connection, can also be a detachable connection, or being integrated; can be a mechanical connection, can also be an electrical connection; can be a direct connection, can also be an indirect connection via through an intermediate medium, can be a communication within the two components or an interaction between the two components. For ordinary technicians in the field, the specific meaning of the above terms in the present disclosure can be understood in specific circumstances.

In embodiments of the present disclosure, unless otherwise expressly specified and limited, the first feature is “above” or “below” the second feature may include a direct contact between the first and the second features, or may include a contact between the first and second features not directly but via another feature between them. Furthermore, the first feature “above”, “up” and “upward” the second feature include the first feature being directly above and diagonally above the second feature, or simply indicating that the first feature is at a higher level than the second feature. The first feature “below”, “down”, and “downward” the second feature include the first feature being directly below and diagonally below the second feature, or simply indicating that the first feature is at a lower level than the second feature.

In the description of this embodiment, the terms “up”, “down”, “right”, etc., azimuth or position relation are based on the azimuth or position relation shown in the drawings only for the purpose of facilitating description and simplifying operation, and are not intended to indicate or imply that the apparatus or element referred to must have a particular orientation, construction and operation in a particular orientation, and therefore cannot be construed as a restriction on the present disclosure. In addition, the terms “first” and “second” are used only to distinguish in terms of description and have no special meaning.

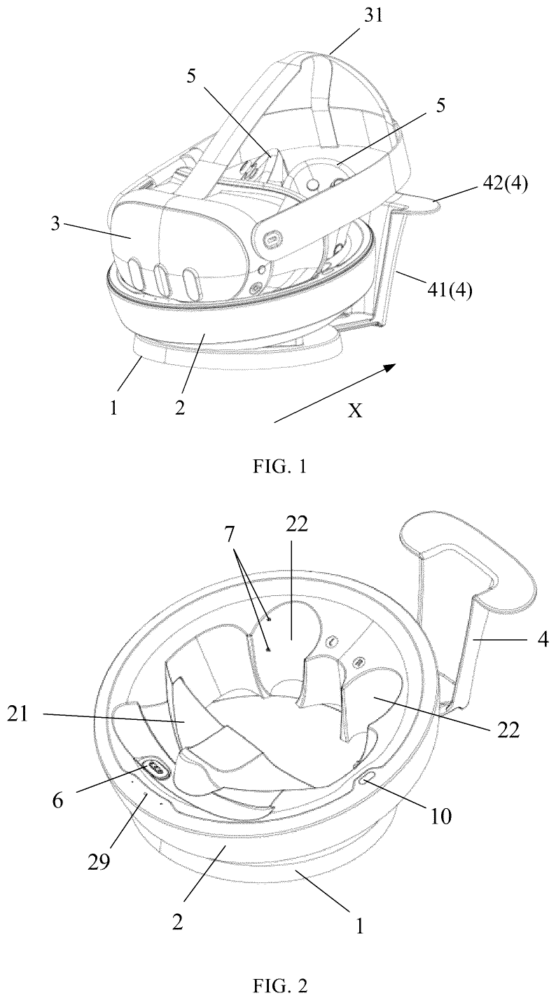

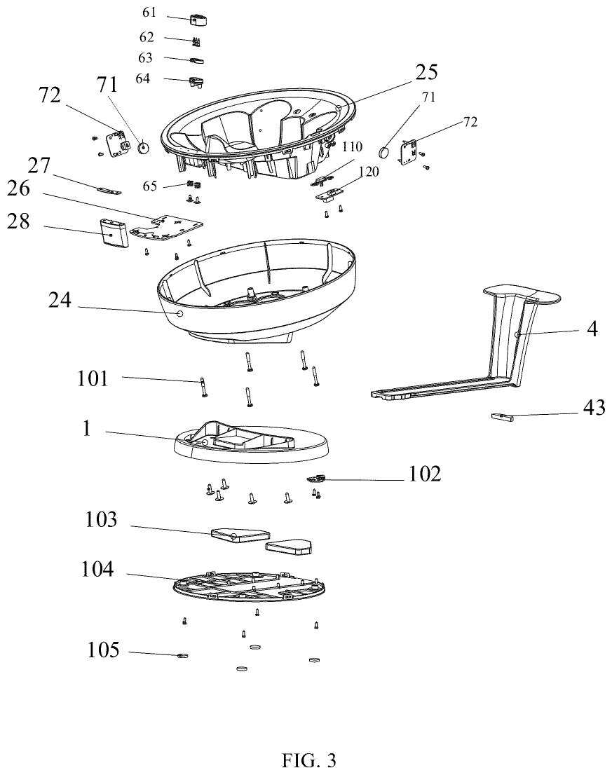

FIG. 1 a structure diagram of a VR device and a charging dock thereof provided by embodiments of the present disclosure; FIG. 2 is a structural diagram of a charging dock for a VR device provided by embodiments of the present disclosure; and FIG. 3 is an exploded diagram of a charging dock for a VR device provided by embodiments of the present disclosure. As shown in FIG. 1 to FIG. 3, a charging dock for a VR device is provided in the embodiments of the present disclosure. The charging dock for the VR device comprises a base 1 and a charging bin 2. The charging bin 2 is disposed tilted on base 1, and a tilting direction is in the direction of arrow X as shown in FIG. 1. The charging bin 2 is provided with a VR device containing cavity 21 and a control device containing cavity 22. A first charging apparatus 6 is provided in VR device containing cavity 21, and a second charging apparatus 7 is provided in control device containing cavity 22. When the VR device 3 is placed in the VR device containing cavity 21, the first charging apparatus 6 is able to charge the VR device 3, and when the control device 5 is placed in the control device containing cavity 22, the second charging apparatus 7 is able to charge the control device 5. The first charging apparatus 6 is disposed in parallel with the charging interface 32 on the VR device 3. When the VR device 3 is placed in the VR device containing cavity 21, the first charging apparatus 6 is connected with the charging interface 32 in parallel.

The base 1 is able to support the charging bin 2 to maintain stability. When the base 1 is placed on a table, the charging bin 2 is tilted relative to the table, and the control device 5 and the VR device 3 in the containing cavity are also tilted. The obliquely disposed VR device 3 can make its center of gravity more stable and not easily displace or roll over.

Further, the bottom of the charging bin 2 is provided with a first clip, the top of the base 1 is provided with a second clip, and the first clip and the second clip can be connected in a matching manner, so that the charging bin 2 is connected to the base 1. In addition, the charging bin 2 and the base I can be further firmly connected via a fastener 101 (a screw, etc.). In order to facilitate the charging dock to access the power supply, the base 1 is also provided with a power supply board and a power interface 102, which can supply power to the charging dock by connecting the external power cable to the power interface 102. In addition, a counterweight block 103 is installed inside the base 1, which can make the center of gravity of the base 1 more stable. In order to improve the anti-slip performance of the base 1, the base cover 104 of the base 1 is also pasted with anti-slip pad 105.

The VR device 3 described above can be considered as a VR headset with built-in power supply, which needs to be worn on the user's head via a strap 31, and the host of the device is fitted to the eye area of the face. The control device 5 is mainly an operation handle, and the user can control VR device 3 via the operation handle, so as to get a better experience. Due to this form structure of VR device 3, when VR device 3 is placed on the table, the strap 31 can easily prop up the host of VR device 3, which will cause the first charging apparatus 6 in the charging bin 2 and the charging interface 32 on VR device 3 being parted from each other in distance, and it is difficult for the VR device 3 to charge stably in the charging bin 2. In addition, because the main weight of VR device 3 is concentrated on the host, when the VR device 3 is placed flat, the VR device 3 is easy to move due to the instability of the center of gravity, which further makes it difficult for the VR device 3 to be stably charged in the charging bin 2.

In the technical solution provided by the present disclosure, the charging bin 2 is disposed on the base 1 obliquely, and the VR device 3 can be obliquely placed in the charging bin 2 accordingly, thus effectively avoiding the problem of unstable center of gravity of the VR device 3. In addition, the first charging apparatus 6 in the charging bin 2 is parallel to the charging interface 32 on the VR device 3, and the first charging apparatus 6 can be stably interfaced with the charging interface 32, the stable and reliable charging is ensured.

Further, as shown in FIG. 3, the charging bin 2 comprises a bottom casing 24 and a cover casing 25, the cover casing 25 can cover and buckle on the bottom casing 24, and the main charging circuit board 26 is disposed in a cavity between the bottom casing 24 and the cover casing 25. In order to facilitate user observation, the main charging circuit board 26 is also provided with an indicator light, the indicator light is provided with astigmatic paper 27, a silicone shading cover 28 is provided around the indicator light, which can prevent the light emitted from the indicator light from entering multiple light transmission holes 29, the light emitted from the indicator light can only be illuminated from the specified light transmission hole 29. In order to facilitate the user's operation of the charging bin 2, the charging bin 2 is also provided with a switch assembly 10. The switch assembly 10 comprises an operating key 110 and a control board 120, and the control board 120 is connected to the cover casing 25 by a screw.

As shown by FIG. 2 and FIG. 3, in an embodiment provided by the present disclosure, in order to facilitate docking the charging interface 32 on the VR device 3 with the first charging apparatus 6, and facilitate docking the charging interface 32 on the control device 5 with the second charging apparatus 7. The first charging apparatus 6 is arranged on the side wall of the edge of the VR device containing cavity 21, and the second charging apparatus 7 is arranged on the side wall of the control device containing cavity 22. Along the tilting direction of charging bin 2, the VR device containing cavity 21 is located at a front side of the control device containing cavity 22. It can be understood that the height of the front side of the charging bin 2 is lower, and the VR device 3 is placed at the lower position of the charging bin 2, which is conducive to the stability of the entire charging dock.

Further, the VR device containing cavity 21 and the control device containing cavity 22 can be an integrated structure, or they can be separated from each other. The VR device containing cavity 21 is formed in a concave structure and matches part of the shell of the VR device 3. When the VR device 3 is placed in the VR device containing cavity 21, the wall of the containing cavity can be matched and fitted with the shell of the VR device 3. Similarly, the containing cavity 22 of the control device is also in a concave structure and matches part of the shell of the control device, and the wall of the containing cavity can be matched and fitted to the shell of the control device 5.

In the technical solution of the present disclosure, the charging bin 2 can not only charge the VR device 3 and the control device 5, but also can be used for the storage of the VR device 3 and the control device 5. By setting the VR device containing cavity 21 and the control device containing cavity 22 in a concave structure matching the shells of the VR device 3 and the control device 5, the VR device 3 and the control device 5 can be placed more stable, and the two devices are not easy to move or shake, which can effectively ensure the stability of the charging connector connection and avoid the collision between the two devices.

Referring to FIG. 2 and FIG. 3, in an embodiment provided by the present disclosure, the first charging apparatus 6 is provided with a first magnetic member 63, and when the first charging apparatus 6 is interfaced with the charging interface 32, the first charging apparatus 6 can extend from the containing slot 200 and attract and attach the charging interface 32. Since the shape of the VR device containing cavity 21 matches the shape of part of the shell of the VR device 3, the VR device 3 can be easily placed in the correct position, and the first charging apparatus 6 can also be accurately aligned with the charging interface 32. Under the action of the first magnetic member 63, the first charging apparatus 6 can attract and attach the charging interface 32, which can be attracted by the first magnetic member 63, to achieve the electrical connection, and then the charging dock can charge the VR device 3.

Further, the first charging apparatus 6 also comprises a top cover 61, a bottom cover 64, a charging pogo pin 62 and a reset piece 65, the charging pogo pin 62 is disposed on the top cover 61, the first magnetic member 63 is bonded to the top surface of the bottom cover 64, and the top cover 61 is covered and buckled on the top surface of the bottom cover 64. Specifically, the charging pogo pin 62 is fixed connected to the top cover 61, which can be riveted to a fixed position of the top cover 61 via the riveting process, the charging pogo pin 62 protruded from the surface of the top cover 61, and the charging pogo pin 62 is mainly used for electrical connection with the charging interface 32. The first magnetic member 63 is disposed between the top cover 61 and the bottom cover 64, the bottom surface of the bottom cover 64 is provided with a groove, the first magnetic member 63 can be connected to the groove by bonding. Under the action of the first magnetic member 63, the first charging apparatus 6 is magnetic, and when the first charging apparatus 6 is attracted, it can be extended from the cavity wall of the VR device containing cavity 21, so that it is easier to connect with the charging interface 32 on the VR device 3.

When the VR device 3 is taken away, in order to enable the first charging apparatus 6 to retract, the reset piece 65 is disposed on the bottom surface of the bottom cover 64, one end of the reset piece 65 is connected against the bottom cover 64, and the other end is connected against the housing of the charging bin 2. The elastic force provided by the reset piece 65 is used to drive the bottom cover 64 to retract, that is, the first charging apparatus 6 is returned, avoiding the charging pogo pin protruding from the wall of the VR device containing cavity 21 for a long time. The reset piece 65 includes but are not limited to: a spring, an elastic rope, an elastic block, etc.

In order to make the connection between the first charging apparatus 6 and the charging interface 32 more stable, in addition to the use of iron materials, a second magnetic piece can also be provided in the charging interface 32. When the VR device 3 is placed in the VR device containing cavity 21, the second magnetic piece attract the first magnetic member 63 to drive a compress of the reset piece 65, the first charging apparatus 6 extends, and attracts and attaches the charging interface. When the VR device 3 is far away from the VR device containing cavity 21, the first charging apparatus 6 is no longer subjected to the magnetic force, and the elastic force of the reset piece 65 can drive the first charging apparatus 6 back.

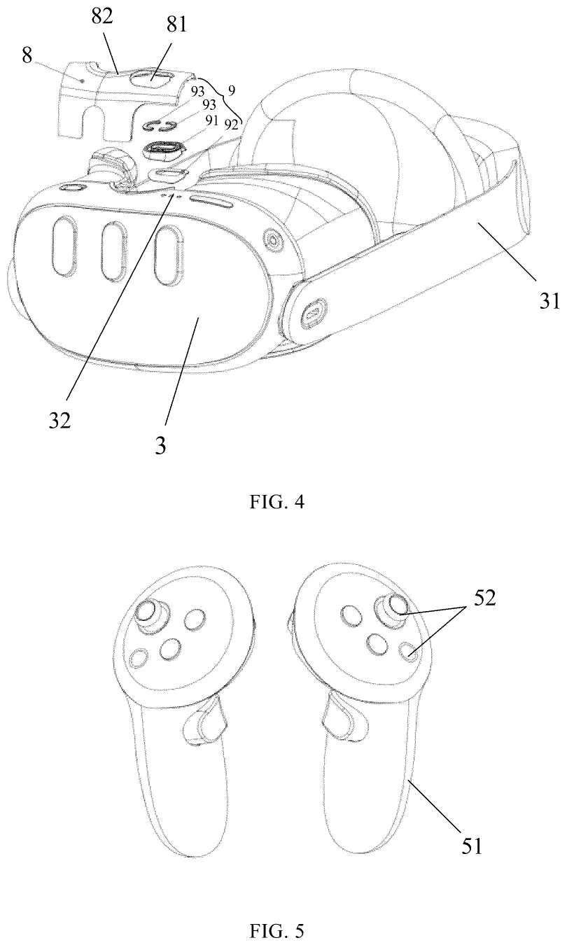

Not all charging interfaces 32 of the VR devices 3 are provided with a magnet, or can be attracted by the first magnetic member 63. For example, some older models of VR device 3, when the manufacturer designs VR device 3, may not take into account the way of magnetic charging, so these VR devices 3 can not match the charging dock provided by the present disclosure for charging. In order to solve this problem, as shown in FIG. 4, the charging dock for the VR device 3 provided by the present disclosure also includes a positioning bracket 8 and a magnetic attracting piece 9, and the positioning bracket 8 can be used to assist the installation of the magnetic attracting piece 9 at the position of the charging interface 32 of the VR device 3. Specifically, the positioning bracket 8 comprises a positioning structure 82 and a mounting hole 81. The positioning structure 82 is matched with a part of the shell of VR device 3. When the positioning structure 82 is installed in place, mounting hole 81 is matched and aligned with the charging interface 32, and the magnetic attracting piece can be installed on the outside of charging interface 32 via the mounting hole 81.

Further, the magnetic attracting piece 9 comprises a magnetic attracting cover 91, a third magnetic piece 93 and a connecting piece 92. The magnetic attracting cover 91 is provided with an opening hole, the third magnetic piece 93 is disposed at the edge of the opening hole, and the connecting piece 92 is used to connect the magnetic attracting cover 91 to the shell of the VR device 3. The third magnetic piece 93 is disposed on the magnetic attracting cover 91, and then the magnetic attracting cover 91 disposed on the shell of the VR device 3, which can increase the aesthetic of the magnetic attracting piece 9, so that the magnetic attracting piece 9 and the VR device 3 are better integrated together, and the whole VR device 3 looks more beautiful. The third magnetic piece 93 can be a magnet or a material that can be adsorbed by the first magnetic member 63. Usually the connecting piece 92 is adhesive, the magnetic attracting cover 91 can be tightly connected with the shell of VR device 3 via adhesive, in addition, the connecting piece 92 can also be a buckle, screw, etc. In one specific embodiment, the magnetic attracting piece matches the size of mounting hole 81 on the positioning bracket 8. When installing the magnetic attracting piece 9, the positioning bracket 8 is first installed in place, and the magnetic attracting piece 9 is then installed via the mounting hole 81 on the positioning bracket 8. The edge of the opening hole on the magnetic attracting cover 91 is provided with a groove structure, and the third magnetic piece 93 is bonded to the groove structure, and then the adhesive is affixed to the back of the magnetic attracting cover 91. With the auxiliary positioning of the mounting hole 81 on the positioning bracket 8, the magnetic attracting cover 91 can be accurately bonded to the charging interface 32.

Further, the charging interface 32 is located at a position corresponding to the opening hole on the magnetic attracting cover 91. When the VR device 3 is placed in the VR device containing cavity 21, the third magnetic piece 93 will attract the first charging apparatus 6, and the first charging apparatus 6 is connected to the charging interface 32 via the opening hole.

Referring to FIG. 2 and FIG. 3, in an embodiment provided by the present disclosure, the second charging apparatus 7 comprises a fourth magnetic member 71 and a charging column arranged at an interval, the charging column is disposed on the second charging circuit board 72, the fourth magnetic member 71 is disposed corresponding to a control device containing cavity 22, and the charging column protrudes from the side wall of the control device containing cavity 22. Taking the fourth magnetic member 71 being a magnet as an example, a mounting slot is arranged on the control device containing cavity 22. The mounting slot can be located on the inside of the cavity wall or on the outside of the cavity wall. The magnet is fixed to the mounting slot via the dispensing process, the charging column passes through the cavity wall and protrudes from the surface of the cavity wall. When the control device 5 is placed in the control device containing cavity 22 for charging, the magnet can be attracted and attached with the magnetic piece of the control device 5, so that the control device 5 is limited, not easy to move, the attracting and attaching of the magnet also means that the control device 5 is in the correct position. The charging column is electrically connected to the charging interface 32 on the control device 5.

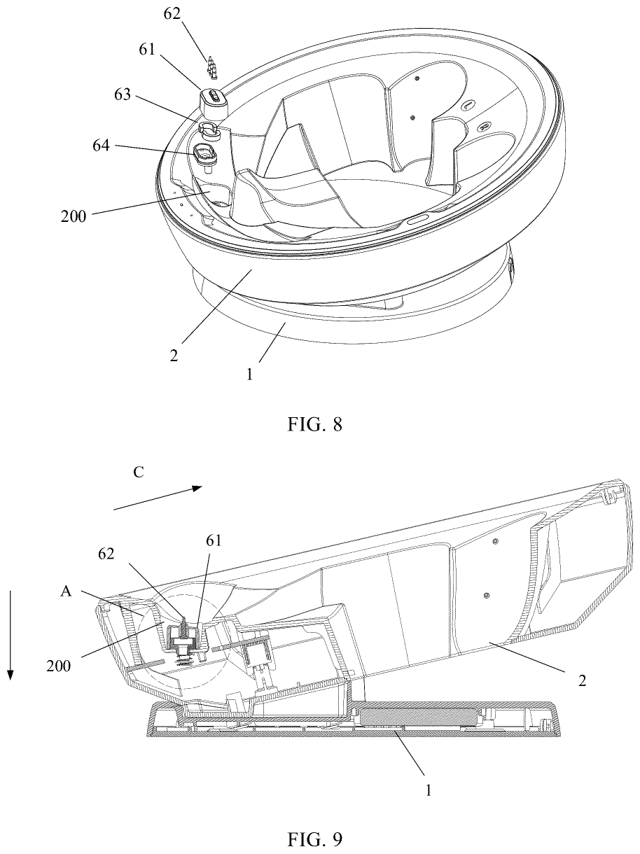

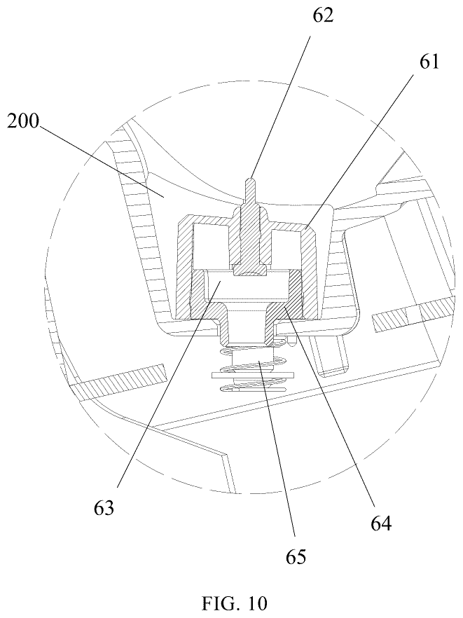

In the above embodiment, in order to facilitate the docking of the first charging apparatus 6 with the charging interface 32, the first charging apparatus 6 can be extended from the cavity wall of the first charging apparatus 21. Therefore, in order to facilitate the disposing of the first charging apparatus 6, as shown by FIG. 8 to FIG. 10, in one embodiment provided by the present disclosure, the cavity wall of the VR device containing cavity 21 is provided with a containing slot 200. The first charging apparatus 6 is disposed in a containing slot 200. When the first charging apparatus 6 needs to be docked with the charging interface 32, the first charging apparatus 6 can be extended from the containing slot 200. When the first charging apparatus 6 is detached from the charging interface 32, the first charging apparatus 6 will be returned to the containing slot 200.

Further, in order to enable the first charging apparatus 6 to have a larger docking range when extended, an end of the containing slot 200 facing outside is in a flaring shape, which can be understood as the slot of the containing slot 200 is a flaring similar to the horn. The first charging apparatus 6 can be extended or retreated along the depth direction of the containing slot 200 (arrow D direction in FIG. 9), in addition, the first charging apparatus 6 can also be tilted out or retreated along a width direction and/or a length direction of the containing slot 200 (arrow C direction in FIG. 9). For example, the first charging apparatus 6 can be inclined forward or backward along the length direction of the containing slot 200 when the notch of the containing slot 200 is a trumpet flaring on both sides. For example, when the notch of the containing slot 200 is a circular trumpet flaring, the first charging apparatus 6 can be tilted out along the width direction or the length direction. In the technical solution provided by the present disclosure, by setting the first charging apparatus 6 into a tilting state, the docking range of the first charging apparatus 6 can be effectively improved. When the VR device is not placed tightly in the VR device containing cavity, the first slave electric apparatus 6 can be accurately connected with the charging interface 32 within a certain deviation range, and the stability of the connection is better.

Further, in one embodiment provided by the present disclosure, the maximum angle of the first charging apparatus 6 being able to tilt forward is different from the maximum angle of the first charging apparatus 6 being able to tilt backward along the length direction of the containing slot 200 (arrow C direction in FIG. 9). The angle range of the first charging apparatus 6 being able to tilt forward is [0 degrees to 20 degrees], and the angle range of the first charging apparatus 6 being able to tilt backward is [0 degrees to 15 degrees]. In one specific implementation, the first charging apparatus 6 can be tilted forward at a maximum angle of 12 degrees, and the first charging apparatus 6 can be tilted backward at a maximum angle of 8 degrees.

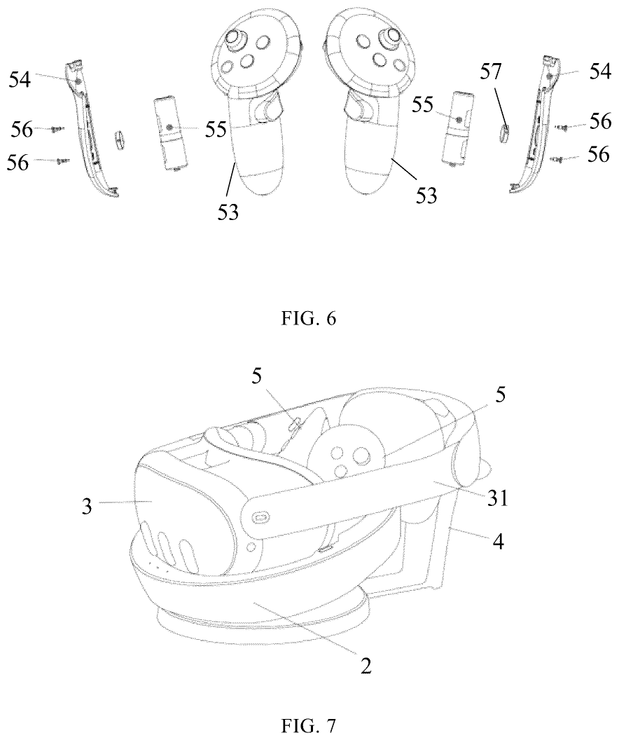

Further, the control device containing cavity 22 includes at least one control device containing position, and when the control device containing cavity 22 has multiple control device containing positions, each control device containing position is provided with one second charging apparatus 7 correspondingly. Generally, in combination with FIG. 5 and FIG. 6, the control device 5 has a rod-shaped holding component 51 and a control button 52. In order to facilitate the stable placing of the control device 5 in the control device containing cavity 22, the control device containing cavity 22 is also a tilted structure, and the tilting direction is the same as that of the charging bin 2. However, the tilting angle of the control device containing cavity 22 is greater than that of the charging bin 2, so as to facilitate the stable placing of the control device 5 in the control device containing cavity 22.

Further, the control device 5 comprises a first shell 53 and a second shell 54, the second shell 54 can be covered and bucked on the first shell 53, a battery 55 and a magnet 57 is provided in the cavity formed by the first shell 53 and the second shell 54, the first shell 53 is also connected with the second shell by a screw 56, and the first shell 53 is provided with a plurality of operating buttons 52.

In order to improve the battery life of VR device 3, some VR devices 3 may be provided with a spare power supply on the strap 31, because the weight of the power supply may further make the center of gravity of VR device 3 unstable. Although the tilted charging bin 2 can improve this situation, when the backup power supply is too heavy, the VR device 3 still cannot be stably placed in the VR device containing cavity 21.

In order to solve this problem, see FIG. 1, FIG. 4 and FIG. 7., in an embodiment provided by the present disclosure, the charging dock for the VR device 3 also comprises a support frame 4, which comprises a connecting component 41 and a support component 42. The support component 42 is disposed at the end of connecting component 41, and the other end of connecting component 41 is used for connecting with base 1 or charging bin 2. Along the tilting direction of charging bin 2, the support component 42 is located at the rear side of the charging bin 2, and the support surface of support component 42 is higher than the top of charging bin 2. Specifically, along the tilting direction of the charging bin 2, the connections between the front end, the back end and the support component 42 of the charging bin 2 are roughly flush with the tilting direction. When the host of VR device 3 is disposed in the VR device containing cavity 21, the support component 42 can be used to support the strap 31, so that the front and back of the entire VR device 3 can be effectively supported, the VR device 3 is more stable, and the charging interface 32 is not easily separated from the first charging apparatus 6.

In a specific embodiment, the connecting component 41 of the support frame 4 is an L-shaped structure, the first end of the connecting component 41 is provided with a slide rail, the base 1 is provided with a slide groove, the slide rail can be disassembled and connected to the slide groove, the first end of the connecting component 41 is also provided with a anti-slip pad mounting slot, the silicone anti-slip pad 43 is pasted in the anti-slip pad mounting slot, when the slide rail is inserted into the slide groove, the silicone anti-slip pad 43 ensures stable connection between connecting component 41 and base 1.

Finally, it should be noted that the above embodiments are only used to illustrate the technical solution of the present disclosure, and not to restrict it; Notwithstanding the detailed description of the present disclosure by reference to the foregoing embodiments, it should be understood by persons of ordinary skill in the art that the technical solution recorded in the foregoing embodiments may still be modified or equivalent to some of the technical features thereof; These modifications or replacements do not separate the essence of the corresponding technical solution from the spirit and scope of the technical solution of each embodiment of the present disclosure.

Finally, it should be noted that the above-mentioned embodiments are only specific implementations of the present disclosure and are used to illustrate the technical solutions of the present disclosure rather than to limit them. The protection scope of the present disclosure is not limited thereto. Although the present disclosure is described in detail with reference to the foregoing embodiments, those of ordinary skill in the art should understand that any person familiar with the technical field can still modify the technical solutions recorded in the foregoing embodiments within the technical scope disclosed in the present disclosure, or changes may be easily imagined, or equivalent substitutions may be made to some of the technical features; and these modifications, changes or substitutions do not cause the essence of the corresponding technical solutions to deviate from the spirit and scope of the technical solutions of the embodiments of the present disclosure, and shall be included in the present disclosure. Therefore, the protection scope of the present disclosure should be determined by the protection scope of the claims.

What is claimed is:

1. A charging dock for a VR device, comprising:
a base,
a charging bin, disposed obliquely to the base, wherein the charging bin is provided with a VR device containing cavity and a control device containing cavity, a first charging apparatus is provided in the VR device containing cavity, and a second charging apparatus is provided in the control device containing cavity;
wherein, the first charging apparatus is disposed in parallel with a charging interface on the VR device, and when the VR device is placed in the VR device containing cavity, the first charging apparatus is docked in parallel with the charging interface.

2. The charging dock for the VR device according to claim 1, wherein the VR device containing cavity is located at a front side of the control device containing cavity, along a tilting direction of the charging chamber;
the first charging apparatus is disposed on a side wall of an edge of the VR device containing cavity; and
the second charging apparatus is disposed on a side wall of the control device containing cavity.

3. The charging dock for the VR device according to claim 2, wherein a containing slot is provided in the VR device containing cavity, the first charging apparatus is provided in the containing slot, and the first charging apparatus is able to extend from the containing slot to dock with the charging interface.

4. The charging dock for the VR device according to claim 3, wherein the first charging apparatus is provided with a first magnetic piece, and when the first charging apparatus is docked with the charging interface, the first charging apparatus is able to extend from the containing slot and attract and attach the charging interface.

5. The charging dock for the VR device according to claim 4, wherein the first charging apparatus comprises: a top cover, a bottom cover, a charging pogo pin and a reset piece;
the charging pogo pin is disposed on the top cover, the first magnetic piece is bonded to a top surface of the bottom cover, and the top cover covers and buckles on the top surface of the bottom cover; and
the reset piece is disposed on a bottom surface of the bottom cover, one end of the reset piece is connected against the bottom cover, and the other end of the reset piece is connected against a housing of the charging bin, for driving the bottom cover to retract.

6. The charging dock for the VR device according to claim 5, wherein a second magnetic piece is provided in the charging interface, when the VR device is placed in the VR device containing cavity, the second magnetic piece attracts the first magnetic member, to drive a compress of the reset piece, the first charging apparatus extends, and attracts and attaches the charging interface.

7. The charging dock for the VR device according to claim 3, wherein an end of the containing slot facing outside is in a flaring shape, the first charging apparatus is able to extend or retreat along a depth direction of the containing slot, and is also able to tilt out or retreat along a width and/or a length direction of the containing slot.

8. The charging dock for the VR device according to claim 7, wherein a maximum angle of the first charging apparatus being able to tilt forward and a maximum angle of the first charging apparatus being able to tilt backward are different along the length direction of the containing slot; and
an angle range of the first charging apparatus being able to tilt forward is [0 degrees to 20 degrees], and an angle range of the first charging apparatus being able to tilt backward is [0 degrees to 15 degrees].

9. The charging dock for the VR device according to claim 1, further comprising: a positioning bracket and a magnetic attracting piece;
wherein the positioning bracket comprises a positioning structure and a mounting hole, and the positioning structure is matched with a part of a shell of the VR device, when the positioning structure is installed in place, the mounting hole is matched and aligned with the charging interface, and the magnetic attracting piece is able to be installed on an outside of the charging interface via the mounting hole.

10. The charging dock for the VR device according to claim 9, wherein the magnetic attracting piece comprises a magnetic attracting cover, a third magnetic piece and a connecting piece;
the magnetic attracting cover is provided with an opening hole, the third magnetic piece is disposed at an edge of the opening hole, and the connecting piece is used to connect the magnetic attracting cover to the shell of the VR device; and
the charging interface is located at a position corresponding to the opening hole, when the VR device is placed in the VR device containing cavity, the third magnetic piece attracts the first charging apparatus, the first charging apparatus is connected with the charging interface via the opening hole.

11. The charging dock for the VR device according to claim 1, wherein the second charging apparatus comprises a fourth magnetic piece and a charging column arranged at an interval; and
the fourth magnetic member is disposed at a position corresponding to the control device containing cavity, and the charging column protrudes from the side wall of the control device containing cavity.

12. The charging dock for the VR device according to claim 2, wherein the control device containing cavity comprises at least one control device containing position, when the control device containing cavity has multiple control device containing positions, each control device containing position is correspondingly provided with one second charging apparatus.

13. The charging dock for the VR device according to claim 1, further comprising a support frame, the support frame comprises a connecting component and a support component;
the support component is disposed at an end of the connecting component, and the other end of the connecting component is used to connect with the base or the charging bin;
along the tilting direction of the charging chamber, the support component is located at a rear side of the charging bin, and a support surface of the support component is higher than a top of the charging bin.

14. The charging dock for the VR device according to claim 4, wherein an end of the containing slot facing outside is in a flaring shape, the first charging apparatus is able to extend or retreat along a depth direction of the containing slot, and is also able to tilt out or retreat along a width and/or a length direction of the containing slot.

15. The charging dock for the VR device according to claim 5, wherein an end of the containing slot facing outside is in a flaring shape, the first charging apparatus is able to extend or retreat along a depth direction of the containing slot, and is also able to tilt out or retreat along a width and/or a length direction of the containing slot.

16. The charging dock for the VR device according to claim 6, wherein an end of the containing slot facing outside is in a flaring shape, the first charging apparatus is able to extend or retreat along a depth direction of the containing slot, and is also able to tilt out or retreat along a width and/or a length direction of the containing slot.
